(19) United States
(12) Patent Application Publication
(10) Pub. No.: US 2004/0051377 A1
(43) Pub. Date: Mar. 18, 2004

(54) Switch in particular a brake light switch for a motor car

(76) Inventor: Evan B. Stringos, G'Mangia (MT)

Correspondence Address: JACOBSON HOLMAN PLLC, 400 SEVENTH STREET N.W., SUITE 600, WASHINGTON, DC, 20004, US

(21) Appl. No.: 10/466,115

(22) PCT Filed: Jan. 23, 2002
(86) PCT No.: PCT/EP02/00651

(30) Foreign Application Priority Data
Jan. 23, 2001 (DE) 101028830

(51) Int. Cl. B60L 1/00

(52) U.S. Cl. 307/10.1

(57) ABSTRACT

A rotatable locking organ (13) is located between a plunger (2) of a switch (1) and a contact maker (16) that is configured as a slide, the rib-type locking elements (15) of said organ engaging in corresponding groove-type locking elements (14) of the plunger. The contact maker is fixed in the axial direction on the locking organ (13), but is mounted so that it can be rotated in relation to said organ. In an initial position of the plunger (2), an anti-torsion device, which can be released by an unlocking action, secures the locking organ (13) against torsion. This allows both the plunger (2) and the contact maker (16) to be accommodated by the housing (4) of the switch so that they can be axially displaced, but are resistant to torsion, thus increasing the adjustment reliability and preventing undesired torsion of the locking organ (13) before the start of the adjustment process.

The invention relates to a switch, in particular a brake light switch for an automobile with an axially displaceable plunger for the actuation of a make-and-break contact of the switch, whereby the plunger protrudes into a bore of a locking organ, which can be rotated relative around the plunger between an adjustment position and a locking position. The plunger and the locking organ have complimentary locking elements that are strung together in a comb-like manner in axial direction. The plunger can be axially adjusted in the adjustment position relative to the locking organ, and the locking organ can be rotated into the locking position in which the locking elements engage into each other in a radial overlapping manner and are fixed in the axial direction after the axial adjustment process has been completed.

Such a switch is known from EP 0840335 A2, for example. According to it, the locking organ is embodied as a slide that glides fixed into the axial direction inside of the switch housing, which carries a contact unit that can make contact with contact components that are seated stationary within the housing. The plunger is supported displaceable in longitudinal direction in the housing and can be rotated by means of a key-like actuating element, in which it is supported stationary and displaceable in longitudinal direction. The actuating element has an actuating finger protruding laterally, which protrudes into one of the recess areas of a mounting port that is embodied in a base component within the pedal space of the automobile.

The actuating finger overlaps the laterally protruding retaining fingers of the housing in the adjustment position of the plunger.

The retaining fingers are embodied corresponding to the recess areas, and can be plugged in through the same, whereby the actuating finger protrudes into the recess area. Once the switch is attached to the base component, the exterior surface end of the plunger that is pushed out of the housing to the maximum degree abuts the spring-loaded pedal lever in its initial position. Due to the fact that the locking element and the ribs are not engaged in the adjustment position, and because a tension spring of the plunger is weaker than the spring force of the pedal lever, the plunger is pushed into the housing and into the slide in a telescoping manner until the front of the housing abuts the base component, and the retaining fingers are completely pushed through the mounting port.

The housing is now rotated around its longitudinal axis so that the retaining fingers engage into the base component in the manner of a bayonet catch, thus fixing the switch. During this rotating motion the actuating finger is retained in the recess area, and thereby rotated in relation to the housing. This rotation is transferred to the actuating component, and therefore to the plunger, which is thereby rotated in relation to the slide that is stationary within the housing. Its groove-type locking elements are rotated to the angular segment of the rib-type locking element and axially fixed, which also causes the slide to be axially fixed onto the plunger. If the brake pedal is now pushed down, the plunger is released, and the slide is displaced against the contact elements together with the contact unit under the force of a compression spring, which causes the contact to be closed and the brake light to turn on.

Because the plunger is especially exposed it may happen that its rotation position is changed before or during the insertion into the mounting port due to unintentional exterior influences, which causes the engagement of the locking elements between the plunger and the slide in an axially false position. However, if a solution is chosen in which the plunger is stationary and the slide is rotated, the powerful frictionally engaging compression spring can be submitted to torsion, thereby exerting a rebound that compromises the safety of the locking position.

The invention is based on the task of increasing the functional safety of the switch

This task is solved by means of the inventions according to claims 1 and 10.

It goes without saying that the sprocket-type locking elements on one of the two locking elements, i.e., on the locking organ, can be reduced down to one sprocket, or one groove, respectively. The actuating component that is rotatable in relation to the locking organ forms a separate coupling component that is rotatable in relation to the plunger and the contact maker that is embodied as a slide so that these two components can be displaced in fixed longitudinal guides within the housing, thus securing the locking device from any damaging influences. The actuating fingers are arranged mostly hidden underneath the retaining finger, and are hard to reach. Any exterior influences cannot take effect until they already protrude into the recess areas of the mounting port, and can then be rotated only conventionally. Any misalignment is thereby prevented to a large extent.

A similar effect is achieved by means of the unlockable anti-torsion device according to claim 10. It reliably prevents the misalignment of the plunger in relation to the locking organ until immediately before the start of the adjustment process.

Without such an anti-torsion device, even a slight rotation can cause the locking elements to engage and axially block the plunger in the locking organ so that a proper adjustment is no longer possible. Since the assembly into a pedal box of the automobile may possibly occur in a hidden manner without any sight control, any misalignment may not be easily recognized. Based on the invention, the torsion range does not become possible until immediately before the start of the adjustment process after a clearly perceivable minimum stroke so that a premature torsion can be safely avoided. It is of advantage that such a minimum stroke can be generated only by exerting a distinct effort against the effect of the return spring of the plunger, which largely prevents an unintentional caving of the plunger.

The means according to claims 1 and 10 correspond to their effect in so far as they themselves safely prevent a misalignment during a hidden assembly until immediately before the start of the final adjustment process. They supplement and reinforce each other in their effect during the mutual operation in a switch in such a way that a nearly complete adjustment reliability is achieved.

Advantageous further embodiments of the invention are listed in the sub-claims:

An exact allocation of the contact units to the contact elements is possible by means of the fixed guide of the contact maker in the housing according to claims 2 and 3. An unlocking effect is reliably avoided by means of the contact maker.

By means of further embodiments according to claims 4 and 5, the contact unit, the contact maker, and the locking organ are allocated to each other in a simple manner and free of clearance.

By means of further embodiments according to claims 6 and 7, the torsion movement of the actuating pins is transferred to the locking organ in a simple and safe manner. The axial range of torsion of the locking organ enables the axial range of torsion of the plunger and of the contact maker between stoppers after the assembly of the switch into the automobile.

The bore according to claim 8 is guided through the interior end of the plunger so that stalling torques that are applied by the pedal lever are absorbed. Furthermore, the bore and pilot pin may have an out-of-round cross-section that prevents the torsion of the plunger in relation to the housing.

The return spring according to claim 9 enables the reliable attachment of the plunger to the pedal lever during the adjustment process. The return spring embodied as a spiral compression spring is additionally routed in the plunger bore along its entire length, free of any kinks.

The axial release stroke according to claim 11 represents a kinematically simple extension of the adjustment stroke and can be performed with the said adjustment stroke in a single operation. The locking shoulder according to claim 12 can be embodied, for example, as an axially oriented side edge of a locking cam, and can be positioned closely adjacent to the side edges of the overlapping locking elements.

The locking segment according to claims 13 and 14 is arranged in the extended row direction of the locking elements. However, it is offset or broadened in axial direction so far that it covers at least one rib of the opposite locking organ in a positive fit, thus reliably preventing an unintentional torsion. The locking segment comes out of the engagement range of the opposite locking elements by means of the axial stroke of the plunger so that the torsion is no longer blocked.

By means of further embodiments according to claims 15 and 16, the switch can be easily attached to the base component in the manner of a bayonet catch. When the switch housing is rotated, the actuating pins 9 are retained in the recess areas of the base component, and rotated in relation to the housing and to the plunger. This movement is transferred to the locking organ via the actuating component, which is then axially locked on the plunger. The axial torsion range of the locking organ enables the axial torsion range of the plunger and of the contact maker between the stop units after the switch has been installed in the base component of the pedal box.

The invention is explained in more detail in an embodiment example illustrated in the drawing. It shows:

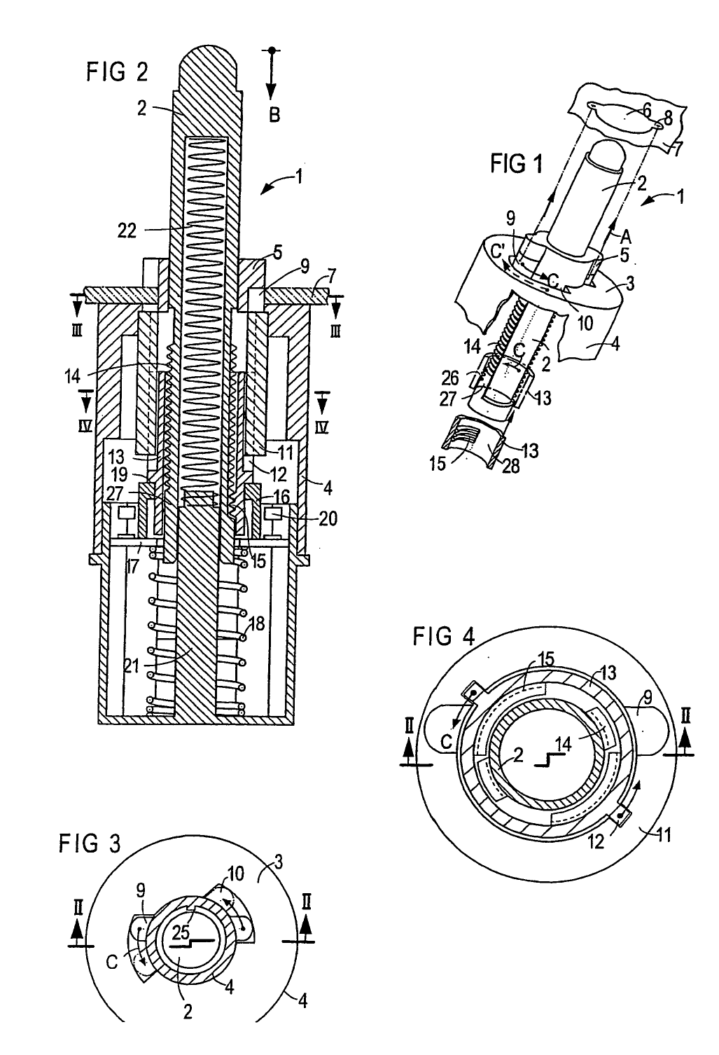

FIG. 1 a perspective partial view of a switch serving as a brake light switch with a plunger,

FIG. 2 a section across the switch according to FIG. 1 along the line II-II in the FIGS. 3 and 4 in an adjustment position with a base component

FIG. 3 a section across the switch along the line III-III in FIG. 2,

FIG. 4 an enlarged partial section across the switch along the line IV-IV in FIG. 2,

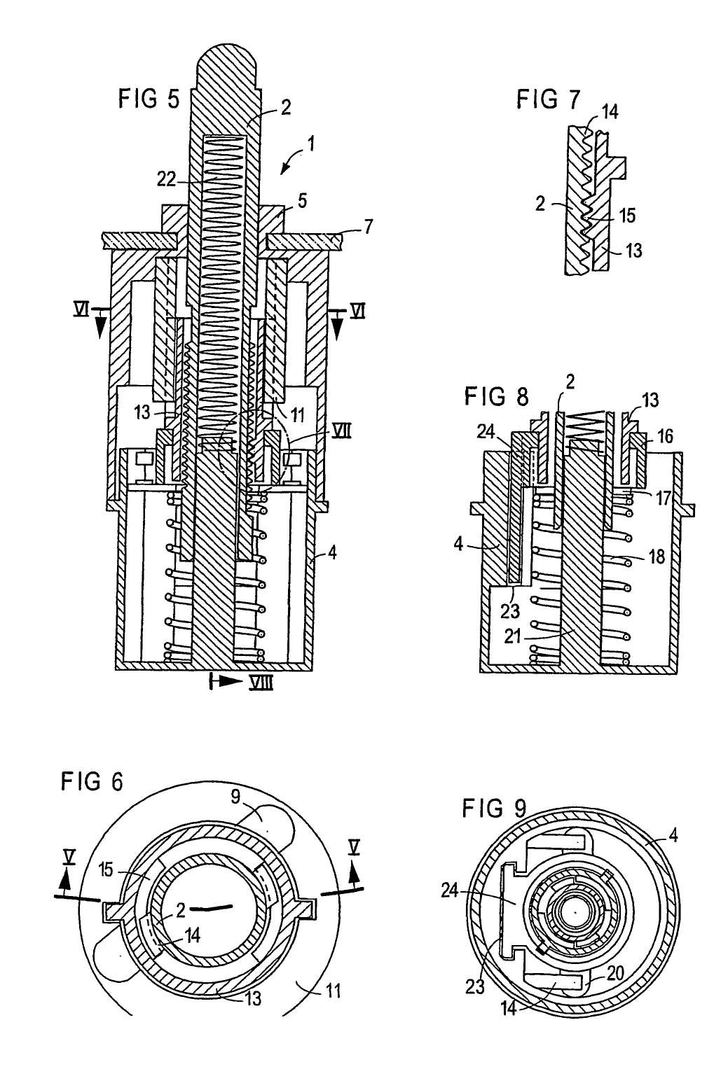

FIG. 5 a section across the switch according to FIG. 2 along the line V-V in FIG. 6 in a locking position,

FIG. 6 an enlarged partial section along the line VI-VI in FIG. 5,

FIG. 7 an enlarged detail VII from FIG. 6

FIG. 8 a partial section across the switch along the line VIII in FIG. 6,

FIG. 9 a top view of the switch parts according to FIG. 8.

According to FIGS. 1, 2, and 3, an essentially cylindrical switch 1 embodied as a brake light switch has an axial plunger 2 that protrudes from one end 3 of the switch 1. A housing 4 of the switch 1 has retaining fingers 5 on the end, which can be plugged through a mounting port 6 of a base component 7 according to the motion arrow A, which is located in the pedal space of an automobile adjacent to the brake pedal lever. The base component 7 has lateral recess areas 8 in the mounting port 6, which are adjusted to the contour of the retaining fingers 5. The asymmetrical contour ensures the correct rotating position of the switch 1 on the base component 7. When inserted into the mounting port, the free plunger end abuts the pedal lever, which pushes the plunger 2 into the switch interior according to the arrow B with the plug-in motion. After the retaining fingers have been plugged in through the mounting port 6, the switch can be rotated according to arrow C′, which enables the retaining fingers 5 to engage into the base component 7 in the manner of a bayonet catch, thus attaching the switch 1 to the base component 7.

Underneath the retaining fingers 5, rotatable actuating pins 9 protrude into the recess areas 8 in the housing 4, which are retained during the rotating of the switch 1 in the recess areas 8, and which can then be rotated in relation to the housing 4 according to arrow C into the locking position indicated by the semicolon line.

In order to enable this rotation, the end 3 of the housing 4 has segmented ring slots 10. The actuating pins 9 are embodied on the end of a pipe-like actuating component 11 that is equipped with parallel longitudinal slots for the fixed guide of respective longitudinal ligaments 12 of a locking organ 13, which is rotated by means of the rotation of the actuating pins 9 with the plunger 2 for the axial locking. At its end the housing 4 has a protrusion 25 that protrudes fixed into a complementary exterior longitudinal groove of the plunger 2.

FIG. 1 shows part of the locking organ 13 in an exploded view outside of the plunger 2 in order to better view its structure. Its actual assembly position is indicated by a semicolon line. Due to its fixed coupling with the actuating pins 9, the locking organ 13 is also rotatable in the direction of arrow C.

The plunger 2 is equipped with transverse, groove-type locking elements 14 that are strung together in the axial direction in the manner of a gear rack. For this purpose, the locking organ has complementary rib-type locking elements 15, which are located in the shown adjustment position outside of the angular area of the groove-type locking elements 14 in free segments 28 formed between the same so that the plunger 2 can be pushed into the pipe-like locking organ 13 in a telescoping manner. In the axial extension of the row of its locking elements 15, the plunger 2 is equipped with a groove-type locking segment 27, which is positioned in an initial position of the plunger 2 at the height of the locking elements 15 of the locking organ 13, and overlaps these locking elements in a circular projection with a lateral locking shoulder 26. This ensures that the locking organ 13 is secured from any torsion of the plunger 2 in the initial position. When the plunger 2 is pushed into the housing 4, the locking segment 27 must initially vacate the area of the locking elements 15 of the locking organ 13 before any rotation and axial fixation are possible.

A fixed, axially displaced contact maker 16 in the housing is equipped with a contact unit 17, which is pushed against the contact maker 16 by means of a spiral-shaped tension spring 18, which again is pushed against a stop shoulder 19 of the locking organ 13 under the force of the spring in a rotatable manner.

In this way, the locking organ 13, the contact maker 16, and the contact unit 17 are fixed against each other in axial direction so that the contact unit 17 can also be pushed against the contact elements 20 by means of the locking organ 13, which are seated stationary in the housing 4. The plunger 2 is equipped with a bore that is open toward the interior, into which a pilot pin 21 of the housing 4 protrudes. A return spring 22 in the form of a spiral compression spring is inserted in the bore and braced between the pilot pin 21 and the interior bore end so that the plunger 2 reliably abuts the pedal lever during the installation phase.

According to FIG. 4, the radii of the partially circular rib-type locking elements 15 and of the segmented groove-type locking elements 14 overlap each other in a circular projection. In the adjustment position shown, however, they are located in different angular segments so that they may slide past each other in the axial direction, and so that the plunger 2 located opposite of the locking organ 13 can be displaced.

According to FIGS. 5 and 6, the plunger 2 is already axially adjusted, and pushed deeper into the switch 1. The locking segment 27 has been pushed out of the area of the locking elements 15 of the locking organ 13, which has cancelled the anti-torsion device. The housing 4 has already been rotated into the locking position, while the actuating pins 9 have rotated with the actuating component 11 and the locking organ 13 relative to the housing 4 and to the plunger 2. In this way the rib-type locking elements 15 of the locking organ 13 that point toward the interior, and the groove-type locking elements 14 of the plunger 2 that are open toward the exterior have engaged in a successive overlapping manner so that the locking organ 13, and therefore also the contact maker 16, is fixed axially opposite of the plunger 2, and can be operated by the same.

FIG. 7 shows the tooth profile of the locking elements (14, 15) of the locking organ 13, and of the plunger 10 in a thread-type engagement free of clearance. In order to facilitate the threading of the locking elements, the same may have chisel-type intake slants on the ends facing each other, which are not illustrated in detail.

FIGS. 8 and 9 show that the housing 4 has a linear guide 23 in the shape of a T-nut in axial direction, in which a respective slide 24 of the contact maker 16 that is embodied as a slide engages free of clearance so that the same is accurately guided in the housing.

### Reference Symbols

1 switch

2 plunger

3 end

4 housing

5 retaining finger

6 mounting port

7 base component

8 recess area

9 actuating pin

10 ring slot

11 actuating component

12 longitudinal ligament

13 locking organ

14 rib

15 locking element

16 contact maker

17 contact unit

18 tension spring

19 stop shoulder

20 contact element

21 pilot pin

22 return spring

23 linear guide

24 slide

25 protrusion

26 locking shoulder

27 locking segment

28 free segment

1. Switch (1), in particular a brake light switch for an automobile with an axially displaceable plunger (2) for the actuation of a make-and-break contact of the switch (1), whereby the plunger (2) protrudes into a bore of a locking organ (13), which can be rotated relative around the plunger (2) between an adjustment position and a locking position. The plunger (2) and the locking organ (13) have complimentary locking elements (15 or 14) that are strung together in a comb-like manner in axial direction. The plunger (2) can be axially adjusted in the adjustment position relative to the locking organ (13), and
the locking organ (13) can be rotated into the locking position in which the locking elements (15, 14) engage into each other in a radial overlapping manner and are fixed in the axial direction after the axial adjustment process has been completed,
characterized that the locking organ (13) in the locking position in the axial direction is kinematically firmly coupled to a separate contact (16), which is seated fixed rotatable in a housing (4) of the switch (1) in the axial direction, and which directly actuates the make-and-break contact.

2. Switch according to claim 1,
characterized that the housing (4) has a linear guide (23) pointing in the axial direction for the contact maker.

3. Switch according to claim 2,
characterized that the linear guide (23) is embodied as a T-nut, into which a respective slide (24) of the contact maker (16) engages.

4. Switch according to claims 1, 2, or 3,
characterized that the make-and-break contact has a contact unit (17) attached to the contact maker (16), which can make contact with contact elements (20) that are anchored within the housing (4) in the locking position; that the contact unit (17) can be pushed against the contact elements (20) by means of a tension spring (18),
and that the tension spring (18) pushes the contact maker (16) in axial direction against a stop shoulder (19) of the locking organ (13).

5. Switch according to claim 4,
characterized that the tension spring (18) is embodied as a spiral compression spring, which pushes the contact unit (17) against the bottom of the contact maker (16), which is facing the opposite side of the stop shoulder (19).

6. Switch according to one of the previous claims,
characterized that the locking organ (13) is routed fixed and axially displaced around a utility stroke of the plunger (2) in an actuating component (11), which together with actuating pins (12) protrudes through segmented ring slots (19) of one end (3) of the switch (1).

7. Switch according to claim 6,
characterized that the actuating pins (12) protrude underneath hook-type retaining fingers (5) of the housing (4) in the adjustment position,
that the retaining fingers (5) can be plugged through lateral recess areas (8) of a coded mounting port (6) of a base component (7) within the pedal space of the automobile, that the actuating pins (9) protrude into the recess areas (8),
that the retaining fingers (5) are able to engage into the base component (7) in a positive fit in the manner of a bayonet catch by means of rotating the switch (1), and
that the actuating pins (9) are retained in the recess areas (8).

8. Switch according to one of the previous claims,
characterized that the housing (4) has a pilot pin (21) that is coaxial to the plunger (2) on the side facing the interior end of the plunger (2), which protrudes into a bore of the plunger (2).

9. Switch according to claim 8,
characterized that a return spring (22) is inserted into the bore for the plunger (2).

10. Switch (1), in particular a brake light switch for an automobile with an axially displaceable plunger (2) for the actuation of a make-and-break contact of the switch (1), whereby the plunger (2) protrudes into a bore of a locking organ (13), which can be rotated relative around the plunger (2) between an adjustment position and a locking position. The plunger (2) and the locking organ (13) have complimentary locking elements (15 or 14) that are strung together in a comb-like manner in axial direction. The plunger (2) can be axially adjusted in the adjustment position relative to the locking organ (13),
the locking elements (14 and 15) are not engaged in the adjustment position, and the locking organ (13) can be rotated into the locking position in which the locking elements (15, 14) engage into each other in a radial overlapping manner and are fixed in the axial direction after the axial adjustment process has been completed, especially according to claim 1,
characterized that the switch (1) has an unlockable anti-torsion device, which prevents any torsion of the locking organ (13) in relation to the plunger (2) in an initial position of the plunger (2), and
that the locking organ (13) is rotatable in relation to the plunger (2) after an unlocking action has taken place.

11. Switch according to claim 10,
characterized that the unlocking action consists of an axial displacement of the plunger (2) from the initial position into the adjustment position, and that the entire axial displacement travel of the plunger (2) is equal to the adjustment travel plus the unlocking travel.

12. Switch according to claims 19 or 11,
characterized that the locking elements (14 and 15) are not engaged in succession in the alley-type free segments (28) between the complementary locking elements (15 or 14) in the initial and adjustment positions, that the locking elements (14 and 15) radially overlap each other in the locking position,
that the locking organ (13) or the plunger (2) has at least one locking shoulder (26) forming an anti-torsion device, which engages into the initial position before the adjustment stroke of the plunger (2) into the free segments (28), and overlaps with at least one of the locking elements (14 or 15) in a circular projection, and
that the locking shoulder (26) is arranged in succession to a longitudinal end area of the respective locking elements (14).

13. Switch according to claim 12,
characterized that the locking shoulder (26) is embodied as an end edge of a partially ring-type broadened locking segment (27), which is arranged in the axial extension of the row of locking elements (14), and which is congruent with the locking elements (14) in the axial projection.

14. Switch according to claims 12 or 13,
characterized that the locking segment (27) is arranged on the interior plunger end in succession of its locking elements (14), and overlaps at least one of the locking elements (15) of the locking organ (13) in the initial position.

15. Switch according to one of the claims 10 to 14,
characterized that the locking organ (13) is fixed and axially displaceable around a utility stroke in an actuating component (11), which protrudes together with the actuating pins (12) through segmented ring slots (19) of one end (3) of the switch (1).

16. Switch according to claim 15,
characterized that the actuating pins (12) protrude underneath hook-type retaining fingers (5) of the housing (4) in the adjustment position, that the retaining fingers (5) can be plugged into the pedal space of the automobile through lateral recess areas (8) of a coded mounting port (6) of a base component (7), that the actuating pins (9) protrude into the recess areas (8),
that the retaining fingers (5) are able to engage into the base component (7) in a positive fit in the manner of a bayonet catch by means of rotating the switch (1), and that the actuating pins (9) are retained in the recess areas (8).
